(19) United States
(12) Patent Application Publication
(10) Pub. No.: US 2005/0167375 A1
(43) Pub. Date: Aug. 4, 2005

(54) Peg board spring for merchandise display

(76) Inventor: Anthony Pagano, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/046,597

(22) Filed: Jan. 28, 2005

Related U.S. Application Data
(60) Provisional application No. 60/540,795, filed on Jan. 30, 2004.

(51) Int. Cl. B42F 1/00

(52) U.S. Cl. 211/54.1

(57) ABSTRACT

A peg board includes an accordion-style folded spring element that automatically pushes merchandise to the front of a display peg. The spring-loaded merchandise display system includes the merchandise display peg with the spring mounted thereon to maintain merchandise hanging from the peg at a forward position.

### REFERENCE TO RELATED APPLICATION

This application claims priority to U.S. Provisional application 60/540,795, filed Jan. 30, 3004, herein incorporated by reference in its entirety.

### FIELD OF THE INVENTION

The present invention generally relates to a display board system for maintaining merchandise on a peg or hook. In particular, the present invention relates to a display board system including display boards having pegs or rails mounted thereon and a flat spring configured to bias merchandise forwardly on the display boards.

### BACKGROUND OF THE INVENTION

In the field of retail merchandising, increasing use has been made in recent years of hook and pegboard or slatboard assemblies for retail display of relatively small merchandise items. Such assemblies typically consist of an upright pegboard or slatboard to which are attached a number of merchandise hooks or pegs. Retail merchandise items are hung from the hooks, typically by way of a merchandise package having a hole punched at its top. The front package on each hook may be easily removed by a customer for examination or purchase, whereupon the next merchandise item on the hook is visibly displayed.

Point-of-purchase merchandise fixtures are fixtures designed to hold and display retail merchandise on a self-serve basis in retail stores or other shopping areas. They are designed to encourage and facilitate selection of items by customers without assistance from sales personnel. The items displayed on these fixtures are customarily purchased when the customer is finished shopping and leaves the store through a cash register terminal.

The hook and pegboard assembly is one of several types of point-of-purchase merchandising fixtures commonly available, also including hook and slatboard assemblies. The retail sales industry has increasingly relied on the hook and pegboard assembly in preference over the other types of fixtures for several reasons.

First, the hook and pegboard assembly presents a neatly arrayed assortment of items. Like items may be grouped together on individual hooks, such that only a single item of each type is displayed at a time. The hooks maintain the merchandise items in an orderly display, yet a customer may nevertheless easily remove an item for examination or purchase and just as easily replace the item without disturbing the display. This is in sharp contrast to bins or shelves. A shelf or bin may be neatly stocked initially, but handling of the goods by customers invariably results in rapid rearrangement of the ordered goods to produce a disordered and unattractive display.

The hook and pegboard display assembly is particularly well adapted to the currently widespread practice of deterring shoplifting by enclosing small retail items in bulky packages. This practice typically takes the form of packaging a small item on a relatively large sheet of cardboard and covering it with a vacuum-formed clear plastic shell, thereby rendering the item bulky and difficult to conceal by a potential shoplifter. Such packages are difficult to display in a pleasing manner in a bin or on a shelf, but can be conveniently displayed on a hook by punching a hole near the upper edge of the cardboard backing and hanging the package from the hook. The hook and pegboard display also further enhances a secondary use of the cardboard backing as an advertising medium whereby printed advertisements may be placed on the front of the cardboard backing around the packaged item. Hanging the items from hooks enables all of the items to be displayed in an upright orientation and facing in the same direction, thus keeping the advertising messages on the cardboard backings properly positioned for easy reading by customers.

The hook and pegboard assembly is also particularly well adapted to displaying goods enclosed in bags, since the bag may be hung by a punched hole in its upper sealed margin. As with the packages described above, the bag itself may be used as an advertising medium as well as a merchandise container, and may be readily displayed in a readable manner on the hook and pegboard assembly.

The hook and pegboard assembly is also preferred because it permits a larger product line to be displayed in a limited retail space compared to other types of fixtures. Individual hooks may be arranged as close together on the pegboard as the sizes of the displayed packages will allow, thereby permitting a relatively high density of different product items to be individually displayed. The particular arrangement of the hooks on the pegboard may also be tailored to best display items of assorted sizes and shapes in an attractive manner. This flexibility permits more efficient use of space than can be attained with racks, shelves or bins. Also, the number of each type of item displayed may be kept small by using inventory cards placed on the hook behind the last package of the hook to facilitate rapid restocking of the items when they are exhausted. This further improves on the efficient use of the available space. No other display device offers such an efficient use of valuable retail space.

Despite the above-mentioned advantages of the conventional hook and pegboard display assembly, certain problems have become apparent. Specifically, one problem with hook and pegboard displays is the decrease in sales due to decreasing visibility of remaining merchandise items after the front packages have been removed from a hook. Especially in a large array of merchandise items hung from hooks, the removal of several packages from the front end of a hook leaves the remaining packages at the back end of the hook partially hidden from view. It is well recognized in the retailing industry that this has a direct negative effect on sales of the remaining items. This also gives an unkempt appearance to the overall display, and sales of all items in the display are thereby also negatively affected somewhat. Decreased visibility is particularly a problem with respect to hooks positioned either higher or lower than average eye level. In these cases, the remaining packages at the back of the hook become almost fully obscured, and the problem becomes similar to the well-known problem in the retail industry of selling goods from a floor-level shelf.

In addition, merchandise having a specific shelf-life and perishable items must be moved to the front of the peg to reduce waste and to allow them to be purchased before the expiration date. Thus, many of the merchandisers that use such assemblies have to hire specific personnel to remain after closing hours daily or weekly to rotate merchandise from the back to the front of the racks as well as to add new merchandise. This requires a considerable amount of personnel time and energy as well as cost to the store.

Accordingly, it is an object of the present invention to provide a hook and pegboard merchandise display device which maintains suspended merchandise items in a neat, orderly array wherein removal of some of the merchandise items does not diminish the visibility of remaining merchandise items on a hook. In addition, it is a further object of the present invention to ensure that this display device be inexpensive, easy to use and maintain, and not easily entangled with the merchandise.

### SUMMARY OF THE INVENTION

In satisfaction of the previously described objectives, embodiments of the present invention provide an improved merchandise display system, which pushes merchandise to the front of a hook.

In accordance with one aspect of the invention, a merchandise display board system is provided. The system includes a peg and a planar compression spring mounted onto the peg. The spring is configured to maintain merchandise at a proximal position on the peg.

In another aspect of the invention, method is provided for displaying merchandise on a peg. The method includes providing a spring that includes a planar element. The planar element is constructed of a memory material has at least two mounting holes and at least one fold along its length. The spring is mounted onto the peg with the peg extending through the mounting holes. The spring is configured to maintain merchandise at a proximal position on the peg.

In accordance with another aspect of the invention, a method is provided for movably displaying merchandise on a peg. The method includes providing a flat compression spring including a planar member with at least three holes and at least two folds. The peg is inserted through the holes in the spring. Merchandise is put on the peg, and the spring is compressed.

In accordance with another aspect of the invention, a spring is configured for biasing merchandise proximally on a display peg. The spring includes a planar member extending from a distal end to a proximal end, and has a plurality of folds and a plurality of openings along the peg axis. The folds are configured to elastically bias toward expansion when compressed along the peg axis.

### BRIEF DESCRIPTION OF THE DRAWINGS

These and other aspects of this invention will be readily apparent from the detailed description below and the appended drawings, which are meant to illustrate and not to limit the invention, and in which:

FIGS. 1 and 2 are top and side views respectively of a preferred embodiment of the spring or planar member.

FIG. 3 is an isometric view of a preferred embodiment of the spring.

FIGS. 4 and 5 are front and side views, respectively, showing a preferred embodiment of the O-ring for holding the flat spring onto the peg or for use as a frictional stopping member.

FIG. 6 is an isometric view of a preferred embodiment of the spring and peg.

FIGS. 7A-C are views of pegboard hooks of the prior art which can be employed with the preferred embodiments of the spring.

### DETAILED DESCRIPTION OF THE PREFERRED EMBODIMENT

An improved merchandise display apparatus will now be described with respect to preferred embodiments; however, the apparatuses of the present invention are not limited to the illustrated applications. Rather, the apparatuses can be used in any display system or environment in which it is advantageous to push items along a peg, rail, rod or hook. Moreover, the apparatuses described herein are merely exemplary and variations can be made without departing from the spirit and scope of the invention.

A merchandise display board system is described in which a peg, rail, rod or hook is configured to advantageously maintain remaining merchandise at a proximal (forward or front) position on the peg, rail, rod or hook as merchandise is removed. The system includes a flat spring or planar member which is configured to bias merchandise toward the front of the peg. The flat spring or planar member contains mounting holes which allow the member to be threaded onto the peg. As merchandise is added, the spring is compressed. Then as merchandise is removed, the spring pushes the remaining merchandise to the front (or proximal end) of the peg. One particularly advantageous embodiment of the spring includes a planar member extending from a distal end to a proximal end, the member having a plurality of folds and a plurality of openings along the peg axis such that the folds have a tendency to elastically expand when compressed along the peg axis. In one embodiment, the planar member preferably has 2-8 holes. It is particularly advantageous for the spring to contain at least 3 holes (and two folds). Further, more than 8 folds will be less advantageous, partly because such a spring will have too much pressure unless it is particularly long. However, the number of folds and holes may be varied according to the length of the spring and the desired force.

It is envisioned that a purchaser can buy a merchandise display board spring of the correct dimensions for use with a specific peg on a previously purchased merchandise display board, such as a pegboard or a slatboard. Examples of manufacturers and distributors of merchandise display boards include, but are not limited to: M. Fried Store Fixtures, Inc., Allen Display, Gershel Brothers Store fixtures, etc. Alternatively, a peg with the spring already attached can be purchased for use on any merchandise display board or variations thereof known to one of skill in the art.

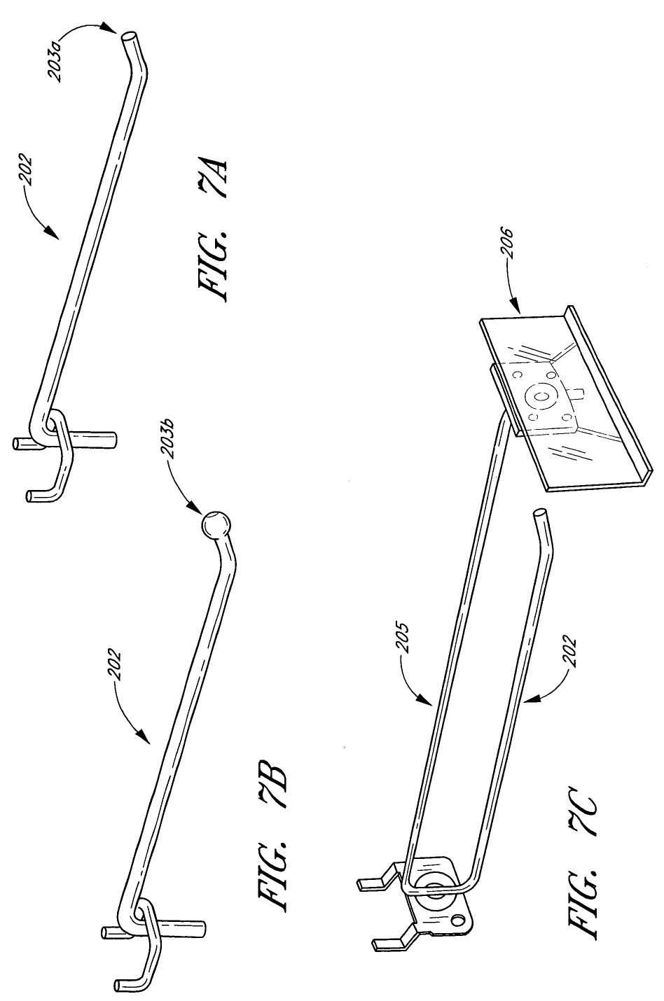

With reference to FIGS. 7A and 7B, examples of pegs which can be purchased for such display boards include but are not limited to pegboard hooks 202 with conventional upturned ends 203a, and pegboard hooks with ball ends 203b. Further examples can be found in catalogs and/or websites of any of the store fixtures stores known to one of skill in the art, for example, Allen Display (allendisplay.com) herein incorporated by reference in its entirety. Typically, the proximal end is slightly raised to reduce the possibility that merchandise will slide off (see FIGS. 7A and 7B). The pegboard hooks can be purchased in a variety of lengths (from about 4 inches to about 12 inches). Further, the weight capacity can vary depending on the weight of the merchandise to be applied to the pegboard hook (for example, standard weight, medium weight, and heavy weight).

With reference to FIG. 7C, label holders can be ordered which attach to, or come attached to, the peg 202 and typically comprise a bar 205 which extends above the peg 202, is typically longer than the peg 202 and contains a platform 206 for any labels to be applied. The bar 205 typically extends above the peg 202 far enough that it does not interfere with the merchandise to be placed on the peg 202 below. Slatwall pegs also include pegs of about 4 inches to 12 inches. Although pegs known to one of skill in the art can be purchased in many sizes, it will be appreciated that any size peg could be accommodated to work with the flat spring or planar members described herein, particularly sizes that fall between those already described, metric sizes, larger sizes and smaller sizes as well as a variety of widths. Thus, it will be appreciated that the peg and spring combination as well as the spring itself are extremely versatile and can be constructed and configured to display products of varying size, weight and configuration.

Preferred embodiments of the spring and peg a spring combinations will now be more completely understood through the following detailed description, which should be read in conjunction with the attached drawings. In this description, like numbers refer to similar elements within various embodiments of the present invention.

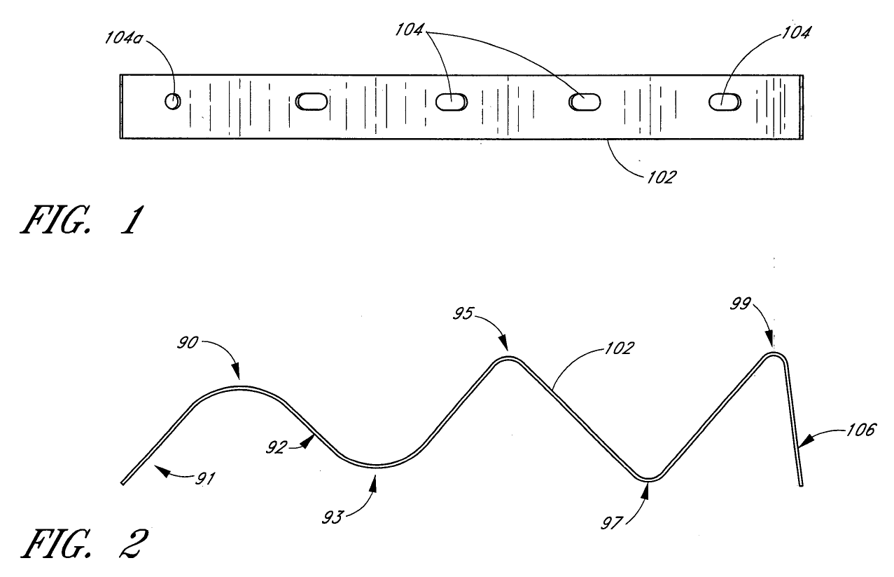

FIGS. 1-3 and 6 illustrate preferred embodiments of the peg board improvement and the flat spring or planar member 102. FIGS. 1-3 are schematic diagrams showing a preferred embodiment of the flat spring or planar member 102, in top, side and isometric views. FIG. 6 is an isometric view of a preferred combination 10 of the planar member or spring 102 attached to the peg 202.

As shown in FIGS. 1-3 and 6, one preferred embodiment of the merchandise display board 10 comprises a spring 102 (which term includes flat spring and planar member) which pushes items along a peg 202 (which term includes pegs, rods, rails, hooks and the like).

With reference to FIG. 6, the peg 202 can be any peg 202 known to one of skill in the art, including those described herein and variants. The peg 202 can be manufactured of any material known to one of skill in the art, including but not limited to: wood, metals, plastics, and cork. In one embodiment, the peg 202 is manufactured of a material which is self lubricating or has a reduced friction to ease the movement of the spring 102 along the peg.

With reference to FIGS. 1-3, the spring 102 is a compression spring configured to attach easily to a peg or hook 202. Preferably, the spring 102 will move easily and with a smooth force of movement along the peg 202 without catching. In one embodiment, the spring 102 is a planar, folded, elastic material, laterally mounted along the peg 202. More particularly, the spring 102 configured for biasing merchandise proximally on a display peg, is preferably a planar member extending from a distal end to a proximal end. The planar member includes a plurality of folds, which act to provide a spring-like activity to the planar member. In addition, the planar member includes a variety of holes (also called openings 104) along the peg 202 axis, which allow the spring 102 or planar member to be threaded onto the peg 202.

Thus, the flat spring 102 can be configured to conform with any merchandise display board and peg 202 known to one of skill in the art or variations thereof. For example, should the peg 202 have a hook at the end, the mounting holes 104 can be lengthened or widened to allow the spring 102 to be threaded onto the peg 202 over the hook. Alternatively, if the peg 202 can be removed from the pegboard or wall 500, the spring 102 can be threaded from the opposite end of the peg 202 and the openings 104 can be sized and shaped to fit over that end.

In one illustrated embodiment, the spring 102 is formed of memory plastic. In the preferred embodiment, the spring 102 comprises a one-inch wide piece of 100% memory plastic with several bends therein. However, the spring 102 can be manufactured of other suitable materials known to one of skill in the art, including but not limited to: aluminum, other metals (iron and steel for example), and plastics. Where materials are not chosen to have low friction, materials such as brass or bronze or any other bearing type surface material may be utilized with a peg 202 which is composed of steels and the like. Additionally, a silicone spray may be used to coat such surfaces to increase the lubrication between the moving components. Any surfaces may be coated, including but not limited to the areas defining the holes 104, and the peg 202 itself.

In further embodiments, the spring 102 can be made to appear more decorative using any methods known to one of skill in the art, including varying the color, adding decorative prints or pictures, or covering the mechanism with paper or a fabric.

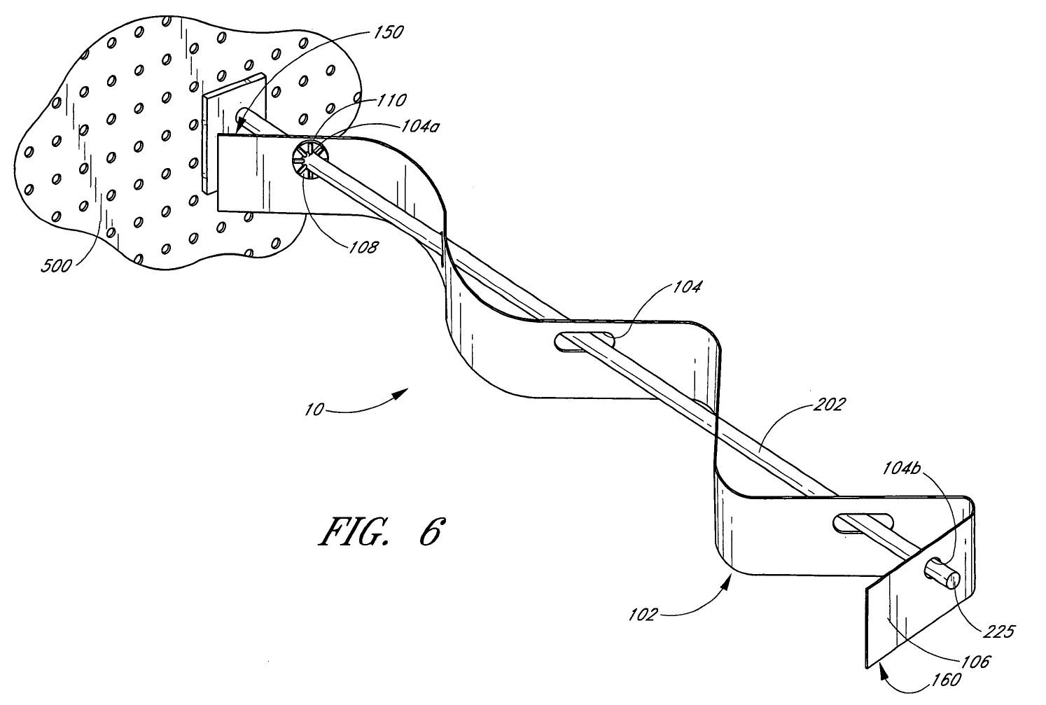

It is contemplated that the spring 102 will have a force which is enough to move merchandise forward with a gentle movement, but not so much to push the merchandise off of the peg 202. However, further embodiments may include a stop block or an apparatus which keeps the spring 102 from coming off of the front of the peg 202. In further embodiments, the spring 102 may have an apparatus which applies a light friction to slow the movement of the spring 102 down. For example, an O-ring 108 (FIGS. 4-6) may be provided at any point on the spring, the O-ring 108 being large enough to contact the peg 202 with a light friction. In the illustrated embodiment, the O-ring 108 contacts the peg 202 with a stronger friction and is applied at the distal end of the peg board assembly 10 to keep the back of the spring 102 in place (see FIG. 6, for example).

As noted, the spring 102 is preferably compression spring, and can have a variety of shapes, including but not limited to: a flat spring, a ribbon spring, a V-type tension spring. Preferably, the spring is a non-coiled spring. It will be understood that the force applied by the spring is directly related to the distance that it is compressed as well as the material and type of spring by the following formula:
F=kD(F=force, D=distance).

Thus, the spring 102 can be selected to provide a specific amount of force depending on the type of the merchandise and heaviness of the merchandise. The illustrated flat spring 102 has characteristics that make it desirable over various other springs, such as helical springs. For instance, the flat spring 102 naturally extends after being compressed and released. The extension involves opening of the spring 102 from its tightly compressed initial state. As the flat spring 102 is compressed, the force exerted varies over its length, unlike that of coil springs in which the force is distributed along its length more evenly during such stretching.

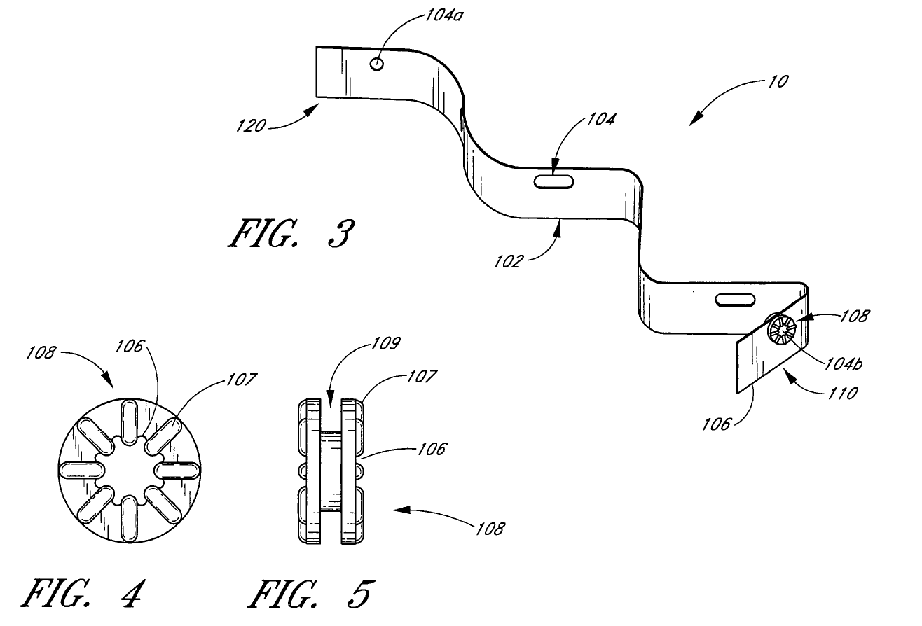

The spring 102 shown in FIGS. 1 and 2 is a planar member having a plurality of folds. The folds can be tight folds 99 as shown near the proximal end or loose folds 90 as shown near the distal end. Typically each fold contains two flat sides 91 and 92 and a corner or arch (see 90, 93, 95, 97 and 99 in FIG. 2). In one embodiment, the tighter fold 99 is at the proximal end and the looser fold 90 is at the distal end. In one illustrated embodiment, the tightness of the folds progressively reduces from the proximal to the distal end. This allows a more constant, smoother force or pressure as the spring 102 or planar member expands.

In one preferred embodiment, the spring 102 contains mounting holes 104, so that it may be stretched along the peg 202 and threaded onto the peg 202. The mounting holes 104 are preferably elongated to allow for movement of the spring 102 along the peg 202 as well as to allow easy mounting of the spring 102 to the peg 202 and to allow for threading the spring 102 over a hook (such as that shown in FIGS. 7A and 7B) onto the peg 202. Alternatively, the mounting holes may be elongated or enlarged to allow the use of one spring 102 with pegs of a variety of thicknesses. Typically, there is one mounting hole 104 per side of the fold (e.g., 91, 92), preferably centrally located between adjacent corners 90, 93, 95, 97, 99. A mounting hole at the proximal or distal end can be made to be smaller to allow for reduced movement at either end (see 104a and 104b in FIG. 3). Further, the mounting holes 104 may be positioned off center (or offset side to side) within each side 91, 92 to allow for smoother movement along the peg 202 as the spring unwinds, because the peg will be less likely to contact the sides of the mounting holes 104.

In one embodiment, at least one end 106 of the spring 102 can be approximately perpendicular to the axis, facilitating the abutment of a large surface area against a product (not shown) positioned on the peg 202, producing a pusher surface 106. Further, the size of the area which is approximately perpendicular to the axis (pusher surface 106) can vary depending on the type and size of merchandise to be moved.

In a further embodiment, the spring 102 contains an O-ring 108, located at the end of the spring 102 furthest from the product, the distal end (see FIG. 6, for example). The O-ring 108 holds the peg 202 through friction. This O-ring 108 allows the tension of the spring 102 to be adjusted through movement of the O-ring 108 along the peg 202. In addition, the O-ring 108 or other such device can be included to increase the friction to either slow movement of the spring 102 along the peg 202 or to stop movement completely. For example, such an O-ring 108 can be placed in the most distal end of the spring 102, as shown in FIG. 6, to hold the spring 102 at a specific point along the peg 202. Alternatively, a looser fitting O-ring 108 can be placed at any of the holes 104 near the proximal end of the spring 102, as shown in FIG. 3, or at an intermediate location, to allow a slower movement along the peg 202. For this purpose, it is envisioned that it will be most advantageous to include the O-ring 108 at the proximal end because the angle of the pusher surface 106 does not change with respect to the peg 202 during compression or expansion. In one embodiment, the O-ring 108 is placed at the proximal hole (104b in FIG. 3 or 104 in FIG. 1) and contacts the peg 202 loosely enough that it can still move as merchandise is removed, but tightly enough that it will stop when it gets to the proximal end 225 of the peg 202, such that the spring will not be pushed off of the peg 202.

With reference to FIGS. 4-6, the O-ring 108 preferably comprises rubber and can be located at the distal or back end of the spring 102. When included in a mounting hole 104a at the distal end 250, the O-ring 108 can advantageously be used to fasten the spring 102 to the peg 202 such that the distal end 250 does not move relative to the peg 202 during expansion. The spring 102 can be positioned on the peg 202 as desired. For example, a spring 102 of 12 inches when relaxed may be positioned on a peg 202 of 14 inches with the distal end of the spring 2 inches from the peg board 500, such that when relaxed the spring 102 will hold the last piece of merchandise at the front (or proximal end) of the peg 202 without pushing it off of the peg. Alternatively, a 4 inch spring 102 can be positioned in the approximate middle of a 10 inch peg.

With reference to FIG. 3, a stopping member 110 can be included at the proximal end of the spring 102 or peg 202 to ensure that merchandise is not pushed off of the peg. Any type of stopping member 110 known to one of skill in the art may be used. For example, an O-ring 108 may be included at the proximal end within a mounting hole 104 (104b in FIG. 3) which allows movement of the spring, but does not allow the spring 102 to exit the peg. In the case of a hook with a ball end (see FIG. 7B), for example, the inner opening defined by the O-ring 108 need only be smaller than the ball end 203b. The O-ring 108 can include one or more cuts through it for easy placement on the peg. In this example, the O-ring 108 may tighten around the peg 202 to keep the spring 102 from exiting or coming off of the peg 202.

One preferred embodiment of the O-ring 108 is shown in FIGS. 4 and 5. In this embodiment, the Q-ring 108 contains a groove 109 which allows it to fit tightly on the planar member 102 within the mounting hole 104. Thus, the groove 109 can be slightly thinner than the thickness of the planar member 102, further, the O-ring 108 may contain leaves 107 which extend radially toward the center of the O-ring 108 and channels 106 which extend radially outward from the middle of the O-ring 108 which can allow for easier compressibility of the O-ring (easier insertion into the mounting hole 104) and can allow for a firm, but moveable, grip or attachment to the peg 202. Further, the firmness of the O-ring 108 can be chosen depending on its purpose and based on its dimensions. For example, a tight O-ring 108 may be chosen for the distal end 150 and a looser O-ring 108 for the proximal end 160.

It will be appreciated by those skilled in the art that in addition to the preferred embodiments described herein, various other omissions, additions and modifications can be made to the method and apparatus described above without departing from the scope of the invention, and all such modifications and changes are intended to fall within the scope of the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein, but instead by reference to claims attached hereto.

1. A merchandise display board system, comprising:
a peg; and
a planar compression spring mounted onto the peg, wherein the spring is configured to maintain merchandise at a proximal position on the peg.

2. The merchandise display board system of claim 1, further comprising at least two mounting holes on the spring.

3. The merchandise display board system of claim 2, further comprising at least a third mounting hole on the spring.

4. The merchandise display board system of claim 2, further comprising an O-ring configured to be placed within a mounting hole.

5. The merchandise display board system of claim 4, wherein the O-ring is attached at one end of the spring.

6. The merchandise display board system of claim 2, wherein the mounting holes are elongated slots.

7. The merchandise display board system of claim 2, wherein the mounting holes allow attachment to the peg.

8. The merchandise display board system of claim 1, wherein the spring is laterally positioned along the length of the peg.

9. The merchandise display board system of claim 1, wherein the spring is a folded elastic material.

10. The merchandise display board system of claim 9, wherein the spring is formed of memory plastic.

11. The merchandise display board system of claim 1, wherein the spring is manufactured of a material that reduces friction between the spring and peg.

12. The merchandise display board system of claim 1, wherein the spring, when expanded, covers substantially the length of the peg.

13. The merchandise display board system of claim 1, further comprising a stopping mechanism to stop the spring from coming off of the peg.

14. The merchandise display board system of claim 13, wherein the stopping mechanism is an O-ring which effectively reduces the size of an opening at the proximal end of the spring.

15. The merchandise display board system of claim 1, wherein the merchandise hangs from the peg.

16. The merchandise display board system of claim 1, further comprising an attachment for the spring onto the peg, board or wall.

17. The merchandise display board system of claim 1, further comprising a pusher surface at the proximal end of the spring which is approximately perpendicular to the axis of the peg.

18. A method for displaying merchandise on a peg, comprising:
providing a spring comprising a planar element, wherein said planar element is constructed of a memory material and has at least two mounting holes and at least one fold along its length; and
mounting the spring onto the peg with the peg extending through the mounting holes, wherein the spring is configured to maintain merchandise at a proximal position on the peg.

19. The method of claim 17, wherein as merchandise is removed, the spring moves proximally, thus pushing the remaining merchandise proximally.

20. The method of claim 17, wherein said spring stops pushing when there is no more merchandise left.

21. A method for moveably displaying merchandise on a peg, comprising:
providing a flat compression spring, wherein said flat compression spring comprises a planar member with at least three holes and at least two folds;
inserting the peg through the holes in the spring;
putting merchandise on the peg; and
compressing the spring.

22. The method of claim 21, wherein the planar member is composed of a memory material.

23. A spring configured for biasing merchandise proximally on a display peg, the spring comprising a planar member extending from a distal end to a proximal end, the member having a plurality of folds and a plurality of openings along a peg axis, the folds configured to elastically bias toward expansion when compressed along the peg axis.

24. The spring of claim 23, wherein at least one of the openings comprises a hole elongated along the peg axis.

25. The spring of claim 24 wherein the spring has smaller holes than the elongated holes at either end.

26. The spring of claim 23, further comprising a pusher surface at the proximal end of the spring, the pusher surface oriented approximately perpendicular to the peg axis.

27. The spring of claim 24, wherein said folds vary in tightness as they advance from the distal end to the proximal end.

28. The spring of claim 26, wherein the tightest fold is at the proximal end and the loosest fold is at the distal end.
